(19) United States
(12) Patent Application Publication
(10) Pub. No.: US 2022/0209636 A1
(43) Pub. Date: Jun. 30, 2022

(54) VIBRATION MOTOR

(71) Applicant: AAC Microtech (Changzhou) Co., Ltd., Changzhou City (CN)

(72) Inventors: Yan Shao, Shenzhen (CN); Xiaorong Zhou, Shenzhen (CN); Fanghua Ling, Shenzhen (CN); Feng Tao, Shenzhen (CN); Yulin Zhang, Shenzhen (CN)

(21) Appl. No.: 17/543,664

(22) Filed: Dec. 6, 2021

(30) Foreign Application Priority Data
Dec. 25, 2020 (CN) 202023222341.3

(51) Int. Cl. H02K 33/02

(52) U.S. Cl. CPC H02K 33/02

(57) ABSTRACT

One of the main objects of the present disclosure is to provide a vibration motor which improves the stability and reliability. To achieve the above-mentioned objects, the present disclosure provides a vibration motor, including: a housing with an accommodation space; a vibration member and a fixed member, an elastic support member suspending the vibration member in the accommodation space. The elastic support member includes a first fixed part fixed on the vibration member, a first elastic arm, a second elastic arm, and a second fixed part. The first fixed part and the second fixed part are respectively located on opposite sides of the vibration member along a vibration direction of the vibration member.

### FIELD OF THE PRESENT DISCLOSURE

The present disclosure relates to electromechanical devices, and more particularly to vibration motor for providing tactile feedback.

### DESCRIPTION OF RELATED ART

The vibration motor generally comprises a vibration member and an elastic support member accommodated in a housing. The elastic support member is used to support the vibration member to be suspended in the housing. The elastic support member of the existing vibration motor is roughly a straight plate structure.

The two elastic support members are located above and below the vibration member, and one end is fixed on the vibration member, and the other end is fixed on the second housing or top wall of the housing. As a result, the arm length of the elastic support member is too short, and the force is too large during the vibration process, which may cause fatigue fracture.

### SUMMARY OF THE PRESENT DISCLOSURE

One of the main objects of the present disclosure is to provide a vibration motor which improves the stability and reliability.

To achieve the above-mentioned objects, the present disclosure provides a vibration motor, including: a housing with an accommodation space; a vibration member and a fixed member accommodated in the accommodation space, an elastic support member suspending the vibration member in the accommodation space and providing elastic restoring force to the vibration member.

The elastic support member comprises a first fixed part fixed on the vibration member, a first elastic arm extending from the first fixed part, a second elastic arm formed by bending and extending from an end of the first elastic arm away from the first fixed part, and a second fixed part formed by bending and extending from the second elastic arm and fixed to the housing. The first fixed part and the second fixed part are located on opposite sides of the vibration member along a vibration direction of the vibration member, respectively.

In addition, an amount of elastic support members is two, and the elastic support members are arranged symmetrically with respect to a center of the vibration member.

In addition, the first fixed part and the second fixed part are parallel to each other; a bending angle formed between the first elastic arm and the second elastic arm is an acute angle; a bending angle between the second elastic arm and the second fixed part is a right angle; and the first elastic arm and the first fixed part are bent for forming an obtuse angle.

In addition, the elastic support member is a sheet metal body and is provided with a through groove penetrating the elastic support member; one end of the through groove extends to the first fixed part, and the other end extends to the second fixed part.

In addition, the housing comprises a first housing having an opening and a second housing closing the opening of the first housing; the first housing and the second housing together form the accommodation space; the vibration member is fixed to the first housing, and the fixed member is fixed to the second housing.

In addition, the first housing comprises a top wall opposite to and spaced from the second housing, and a sidewall bent from the top wall to the second housing.

In addition, the first fixed part is fixed to the upper surface or the lower surface of one end of the vibration member; the second fixed part is fixed at a position of the second housing or top wall away from the one end of the vibration member.

In addition, the vibration member comprises a weight having an accommodation cavity and a magnet accommodated in the accommodation cavity; the fixed member comprises a circuit board provided on the second housing and a coil installed on and electrically connected to the circuit board; the coil at least partially extends into the accommodation cavity and is spaced from the magnet.

In addition, an amount of the magnets is two, and two magnets are respectively located on two sides of the coil, and the polarities of the two magnets are opposite.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric view of a vibration motor in accordance with an embodiment of the present disclosure;

FIG. 2 is a cross-sectional view of the vibration motor taken along line A-A in FIG. 1;

FIG. 3 is a cross-sectional view of the vibration motor taken along line B-B in FIG. 1;

FIG. 4 is an isometric view of the vibration motor with a first housing removed.

FIG. 5 is an exploded and isometric view of the vibration motor shown in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figures and the embodiment. It should be understood the specific embodiment described hereby is only to explain the disclosure, not intended to limit the disclosure.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly comprise one or more of these features.

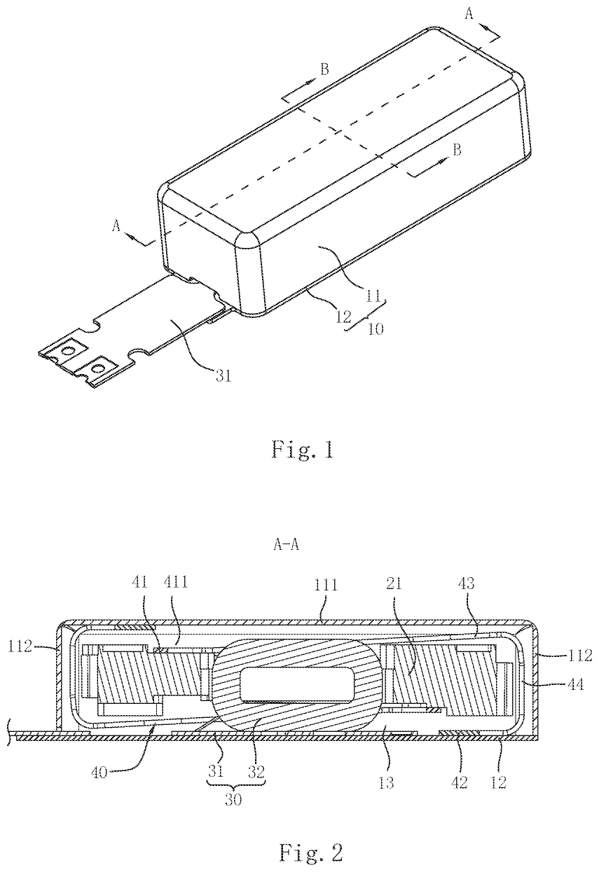

Please refer to FIGS. 1-3, an embodiment of the present disclosure discloses a vibration motor, comprising a housing 10 with an accommodation space 13, a vibration member 20 and a fixed member 30 accommodated in the accommodation space 13, and an elastic support member 40 that suspends and supports the vibration member 20 in the accommodation space 13 and provides elastic recovery force to the vibration member 20.

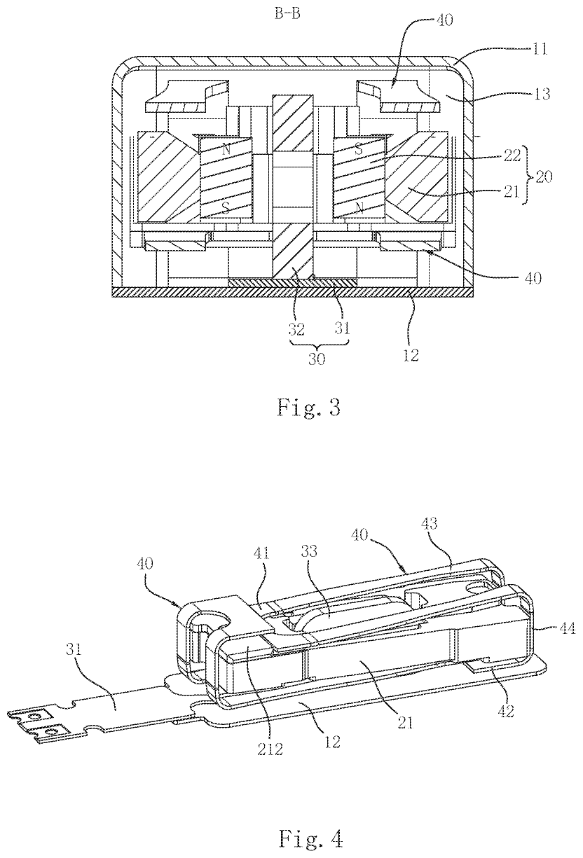

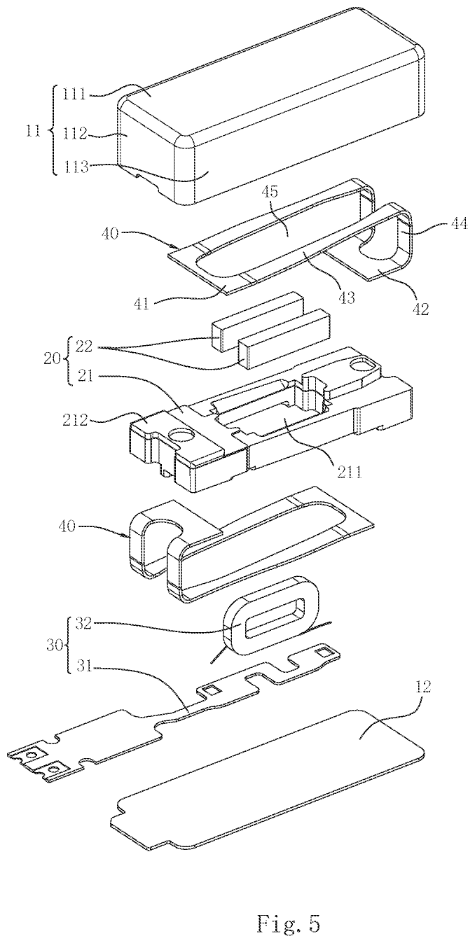

As shown in FIGS. 4-5, the housing 10 is roughly a rectangular parallelepiped structure, and comprises a first housing 10 having an opening and a second housing 12 that closes the opening of the first housing 11. The first housing 11 and the second housing 12 together form the accommodation space 13. The vibration member 20 is fixed to the first housing 11 by the elastic support member 40, and the fixed member 30 is fixed to the second housing 12. Specifically, the second housing 12 is a flat plate structure. The first housing 11 comprises a top wall 111 opposite to the second housing 12 and spaced apart, and a sidewall bent from the top wall 111 to the second housing 12. The sidewall comprises a first sidewall 112 located at opposite ends of the vibration member 20 in the length direction and a second sidewall 113 located at opposite ends of the vibration member 20 in the width direction.

The vibration member 20 comprises a weight 21 provided with an accommodation cavity 211 and a magnet 22 accommodated and fixed on the sidewall of the accommodation cavity 211. The fixed member 30 comprises a circuit board 31 arranged on the second housing 12 and a coil 32 installed on the circuit board 31 and electrically connected to the circuit board 31. The coil 32 extends at least partially into the accommodation cavity 211 and is spaced apart from the magnet 22.

The weight 21 is fixed to the first housing 11 by the elastic support member 40 and serves as the main weight of the vibration member 20. The magnet 22 is used to cooperate with the coil 32 to generate electromagnetic force to drive the longitudinal linear vibration of the vibration member 20. When the elastic support member 40 vibrates up and down in the vibration member 20, it is used to provide elastic restoring force, that is, to provide the linear guiding force and the force to restore the equilibrium position for the vibration member 20 The circuit board 31 is used to enable the coil 32 to be electrically connected with external devices, so as to provide electric energy for the coil 32.

In this embodiment, the accommodation cavity 211 is a through-hole structure that penetrates the weight 21 up and down. The number of the magnets 22 is two, which are respectively located on both sides of the coil 32 and fixed on the two sidewalls of the accommodation cavity 211 in the width direction of the vibration member 20. The polarities of the two magnets 22 are opposite, that is, the two magnets 22 are arranged symmetrically with respect to the center of the coil 32.

In this way, the driving force of the coil 32 on the vibration member 20 is improved, and the vibration feeling of the vibration motor is improved. When the second housing 12 is covered and fixed at the opening of the first housing 11, the coil 32 of the fixed member 30 just extends into the accommodation cavity 211 of the weight 21. It saves the positioning of tooling, optimizes the production and assembly process, saves labor costs, and reduces production costs.

In a specific embodiment of the present disclosure, the number of the elastic support members 40 is two, which are respectively arranged above and below the vibration member 20, and are arranged symmetrically with respect to the center of the vibration member 20. The vibration member 20 is suspended between the two elastic support members 40 and reciprocates under the action of the elastic restoring force provided by the elastic support member 40 to realize the vibration of the vibration motor.

Wherein, the elastic support member 40 comprises a first fixed part 41 fixed on the vibration member 20, a first elastic arm 43 extending from the first fixed part 41, and a second elastic arm 44 formed by bending the end of the first elastic arm 43 away from the first fixed part 41, and a second fixed part 42 formed by bending the second elastic arm 44 and fixed to the housing 10. The first fixed part 41 and the second fixed part 42 are located on opposite sides of the vibration member 20 along the vibration direction of the vibration member 20, respectively.

It should be noted that the arc of the bending position of elastic support member 40 is excessive, and the fixing of the second fixed part 42 and the housing 10 limits the relative position of the elastic support member 40 and the housing 10. The first fixed part 41 is fixed with the vibration member 20, and the suspension setting of the vibration member 20 in the accommodation space 13 is realized. During the up and down vibration of the vibration member 20, the accommodation space 13 inside the housing 10 is effectively utilized through the bending structure of the elastic support member 40, which increases the length of strain area of the elastic support member 40, effectively improves the elastic force of the elastic support member 40, and improves the service life of elastic support member 40.

Preferably, the first fixed part 41 of one of the elastic support members 40 is fixed on the upper surface of the weight 21 of the vibration member 20 along the length direction, and the second fixed part 42 is fixed on the second housing 12. The first fixed part 41 of the other elastic support member 40 is fixed on the lower surface of the other end of the weight 21 along the length direction, and the second fixed part 42 is fixed on the top wall 111 of the first housing 11.

In other words, the two elastic support members 40 are connected to the upper and lower sides of the weight 21 through their respective the first fixed parts 41. That is, the two first fixed parts 41 are respectively connected to the two opposite corners of the weight 21, and the two elastic support members 40 are respectively connected to the top wall 111 and the second housing 12 of the first housing 11 through their respective the second fixed parts 42. Thus, two elastic support members 40 are symmetrical relative to the center of vibration member 20 to avoid polarization of the vibration member 20. It can be understood that the connection between the first fixed part 41 and the weight 21 and the connection between the second fixed part 42 and the housing 10 can be connected by welding or bonding.

In order to realize the welding positioning of the weight 21 and the elastic support member 40, the upper and lower surfaces of the weight 21 are respectively convexly formed with the limit bumps 212. The two limit bumps 212 are located at the two ends of weight 21. When the first fixed part 41 is welded and fixed to the weight 21, the elastic support member 40 and the weight 21 are positioned by pressing against the limit bump 212, so that the assembly is more convenient and faster.

Further, in order to avoid collision between the elastic support member 40 and the vibration member 20, the bending angle between the first elastic arm 43 and the second fixed part 42 is an acute angle, and the bending angle between the second elastic arm 44 and the second fixed part 42 is approximately a right angle, and the first elastic arm 43 and the first fixed part 41 are bent to form an obtuse angle. The bending angle can be set according to the vibration amplitude of the vibration member 20 and the structure of the weight 21, and according to the different structure of the actual weight 21, the first elastic arm 43 and the second elastic arm 44 can also be designed with bending to avoid, which increases the strain length of the elastic support member 40 and increases the elastic restoring force.

In a specific embodiment of the present disclosure, the elastic support member 40 is a sheet metal body, and is provided with a through groove 45 penetrating the front and back of the elastic support member 40, and one end of the through groove 45 extends to the first fixed part 41 and the other end to the second fixed part 42. On the one hand, the elastic force of the elastic support member 40 can be increased, the resonance frequency of the vibration motor can be reduced, and the vibration feeling of the product can be improved; on the other hand, the vibration member 20 can be avoided through the through groove 45, so that the volume of the vibration motor can be decreased.

To sum up, as for the vibration motor of the embodiment of the present disclosure, through the arrangement of multiple bending structures in the elastic support member 40, it effectively utilizes the accommodation space 13 inside the housing 10, increases the length of the strain area of the elastic support member 40, and effectively improves the elastic the elastic force of the support member 40 increases the service life of the elastic support member 40.

When assembling, the vibration member 20 and the elastic support member 40 are welded and fixed, and then the elastic support member 40 is assembled and fixed in the first housing 11, and finally the second housing 12 provided with the fixed member 30 is packaged and fixed to the opening of the first housing 11. The semi-finished product test of the vibration motor before packaging the second housing 12 can be realized, which effectively improves the assembly efficiency and product utilization.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the disclosure to the full extent indicated by the broad general meaning of the terms where the appended claims are expressed.

What is claimed is:

1. A vibration motor, comprising:
a housing with an accommodation space;
a vibration member and a fixed member accommodated in the accommodation space;
an elastic support member suspending the vibration member in the accommodation space and providing elastic restoring force to the vibration member; wherein,
the elastic support member comprises a first fixed part fixed on the vibration member, a first elastic arm extending from the first fixed part, a second elastic arm formed by bending and extending from an end of the first elastic arm away from the first fixed part, and a second fixed part formed by bending and extending from the second elastic arm and fixed to the housing; the first fixed part and the second fixed part are located on opposite sides of the vibration member along a vibration direction of the vibration member, respectively.

2. The vibration motor as described in claim 1, wherein an amount of elastic support members is two, and the elastic support members are arranged symmetrically with respect to a center of the vibration member.

3. The vibration motor as described in claim 1, wherein the first fixed part and the second fixed part are parallel to each other; a bending angle formed between the first elastic arm and the second elastic arm is an acute angle; a bending angle between the second elastic arm and the second fixed part is a right angle; and the first elastic arm and the first fixed part are bent for forming an obtuse angle.

4. The vibration motor as described in claim 1, wherein the elastic support member is a sheet metal body and is provided with a through groove penetrating the elastic support member; one end of the through groove extends to the first fixed part, and the other end extends to the second fixed part.

5. The vibration motor as described in claim 1, wherein the housing comprises a first housing having an opening and a second housing closing the opening of the first housing; the first housing and the second housing together form the accommodation space; the vibration member is fixed to the first housing, and the fixed member is fixed to the second housing.

6. The vibration motor as described in claim 5, wherein the first housing comprises a top wall opposite to and spaced from the second housing, and a sidewall bent from the top wall to the second housing.

7. The vibration motor as described in claim 6, wherein the first fixed part is fixed to the upper surface or the lower surface of one end of the vibration member; the second fixed part is fixed at a position of the second housing or top wall away from the one end of the vibration member.

8. The vibration motor as described in claim 5, wherein the vibration member comprises a weight having an accommodation cavity and a magnet accommodated in the accommodation cavity; the fixed member comprises a circuit board provided on the second housing and a coil installed on and electrically connected to the circuit board; the coil at least partially extends into the accommodation cavity and is spaced from the magnet.

9. The vibration motor as described in claim 8, wherein an amount of the magnets is two, and two magnets are respectively located on two sides of the coil, and the polarities of the two magnets are opposite.
